(19) United States
(12) Patent Application Publication
(10) Pub. No.: US 2006/0275188 A1
(43) Pub. Date: Dec. 7, 2006

(54) ELECTRONIC APPARATUS CAPABLE OF CLEANING UNWANTED DUST AND RELATED METHOD THEREOF

(76) Inventor: Chih-Hsien Wei, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/308,232

(22) Filed: Mar. 14, 2006

(30) Foreign Application Priority Data
Jun. 3, 2005 (CN) 200510074778.8

(51) Int. Cl. B01J 19/12

(52) U.S. Cl. 422/186.3

(57) ABSTRACT

An electronic device is capable of cleaning unwanted dust and related method thereof. An electronic device includes a main body; a mobile light source module disposed within the main body; a transparent plate disposed on the main body and opposite to the mobile light source module; and a photocatalyst layer applied on the transparent plate for receiving light illuminated from the mobile light source module so as to trigger a photocatalyst reaction.

### BACKGROUND OF THE INVENTION

1. Field of the Invention

This invention provides an electric device, and more specifically, an electronic apparatus capable of cleaning unwanted dust, and related method thereof.

2. Description of the Prior Art

Electronic peripheral devices, such as scanners, photostats, multi-function peripheral devices, etc. provide the functions of document scanning or printing, thereby supplying a highly convenient method for work processing.

Please refer to FIG. 1. FIG. 1 is a diagram of a conventional scanner 100. As shown in FIG. 1, the scanner 100 includes a transparent glass layer 110, a light source module 120, and an upper housing 130. As is well known in the field, the transparent glass layer 110 is a transparent plate that can be used to carry an object to be scanned. The mobile light source module 120 provides the object to be scanned with incident light and can be moved while scanning the object; and the upper housing 130 contains the light from the mobile light source module 120 when the scanner is operating. Therefore, the scanner 100 can successfully scan the object.

Unfortunately, when the scanner 100 is operational over a period of time, the transparent glass 110 will accumulate dust on its surface. Obviously, if the amount of dust is too large, particles of dust will not only cover part of the object to be scanned but also directly affect the scan or print quality. A user must therefore purchase tools to remove dust—for example, a user can utilize non-woven clothes or various other cleaning tools to remove said dust—however, these kinds of cleaning methods not only require money but also require time. This is clearly an inefficient method.

### SUMMARY OF THE INVENTION

One of the purposes of this invention is to provide an electric device and certain related methods to enable an electronic device that can clean dirt away by itself, therefore solving the associated prior art problems.

According to the present invention, an electric device that can clean dirt away by itself is disclosed. An electronic device includes a main body; a mobile light source module disposed within the main body; a transparent plate disposed on the main body and opposite to the mobile light source module; and a photocatalyst layer applied on the transparent plate for receiving light illuminated from the mobile light source module so as to trigger a photocatalyst reaction.

The electric device of this invention can remove dirt by itself, therefore, when the scan or print function is operating, the scan or print quality will not be affected by dirt. Users do not need to purchase cleaning cloths or cleaning tools for removing dirt. The claimed invention provides not only an economic solution, but also a more convenient one.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional scanner.

FIG. 2 is a diagram of a scanner according to the present invention.

FIG. 3 is a functional block chart of the scanner shown in FIG. 2.

FIG. 4 is a flow chart of removing dirt according to the present invention.

### DETAILED DESCRIPTION

Dust is almost always a carbohydrate substance. As is well known, a photocatalyst reaction can break the bonds of organic molecules, achieving the goal of removing dust. Therefore, the present invention utilizes the photocatalyst reaction to remove dust and maintain scanning quality.

Generally speaking, a photocatalyst reaction has to provide a catalyst with enough incident light to enable an electron on the surface of the catalyst to absorb sufficient energy to escape, creating a positron in the location of the escaped electron. The positron causes the OH— molecule to oxidize, forming an active hydroxide molecule. The hydroxide molecule will try to obtain an extra electron from remaining organic molecules to replace the one it has lost, thereby breaking the bonds between the organic molecules. As dust particles are generally organic molecules, the photocatalyst reaction can achieve the goal of removing dust and killing bacteria.

As mentioned above, a photocatalyst reaction needs to be triggered. Generally, the catalyst of a photocatalyst reaction is titania, wherein a titania electron is moved from the valence band to the conduction band, by receiving energy from an outside light source. Generally speaking, the wavelength of the outside light source is about 380 nm, which lies in the ultraviolet light region. In other words, in this embodiment, ultraviolet light is the best light source for triggering a photocatalyst reaction.

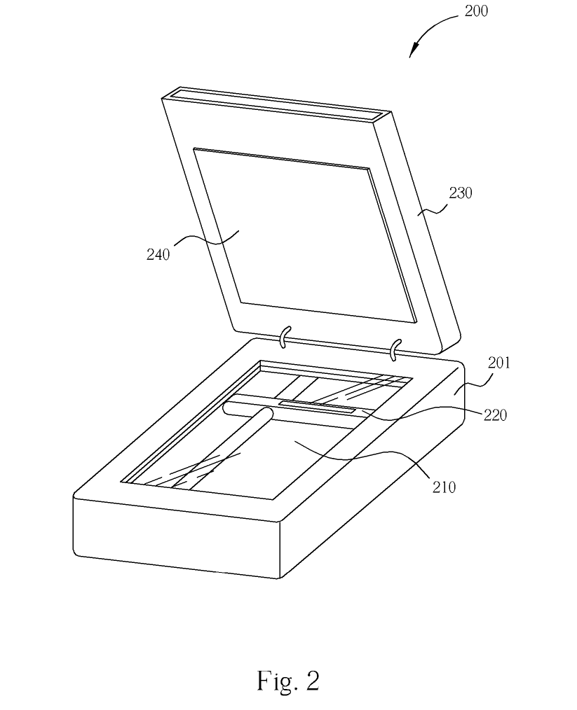

Please refer to FIG. 2, which is a chart of a scanner 200 according to the present invention. As shown in FIG. 2, the scanner 200 includes a main body 201, a layer of transparent plate 210 disposed on the main body 201. Please note, the transparent plate 210 can be used to carry an object (e.g. a document). The scanner further comprises a mobile light source module 220, disposed within the main body for providing light in a scanning process, and an upper housing 230, for containing the light from the mobile light source module 220 during operation.

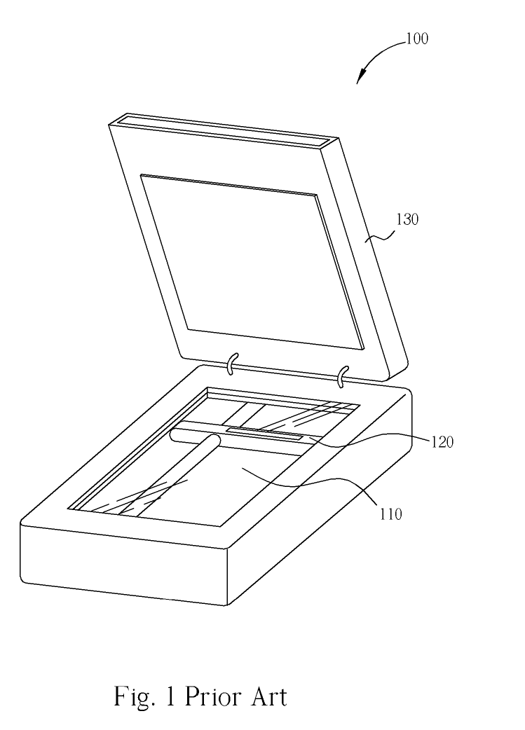

In order to solve the problem of dirt on the transparent glass 110 in the conventional scanner 100 shown in FIG. 1, the present invention scanner 200 utilizes a photocatalyst reaction. That is, in this embodiment, the transparent plate 210 and the contact portion of the upper housing 230 and transparent plate 210 (also including the area 240) are fully coated with titania. This means that a photocatalyst layer is formed on the transparent plate. Obviously, the photocatalyst layer (titania layer) is used to receive lights illuminated from the mobile light source module 220 so as to trigger the above-mentioned photocatalyst reaction.

As mentioned previously, in order to cause titania layer to produce a catalyst reaction, the light source wavelength must be longer than 380 mm. For this reason, an ultraviolet light source has to be provided. Therefore, in this embodiment, in the mobile light source module 220 not only comprises a visible light source, but also an ultraviolet light source (not shown in FIG. 2.) for touching off the catalyst reaction.

Please note, in this embodiment, the present invention takes the combination of titania and outside light source to cause the photocatalyst reaction. However, due to great progress in science and technology a photocatalyst reaction utilizing visible light has been invented. Therefore, other catalysts can be utilized. The titania layer is only regarded as an preferred embodiment, not a limitation of the present invention. If visible light is utilized to initialize the photocatalyst reaction then the mobile light source module 220 no longer comprises the ultraviolet light source. This change also obeys the spirit of the present invention.

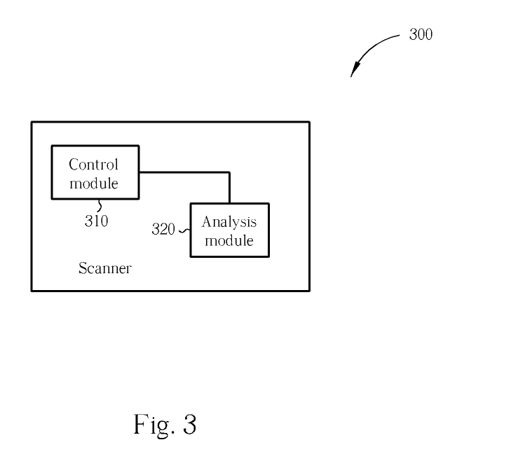

The scanner 200 is not only able to successfully decompose dirt and boost the scanning performance by utilizing a photocatalyst reaction, but can also provides another related mechanism to remove dirt by an optimum photocatalyst reaction. Please refer to FIG. 3. FIG. 3 is a functional block chart of the scanner 200 in FIG. 2. As FIG. 3 shows, the scanner 200 includes a control module 310 that can be used to control the mobile light source module 220, and an analysis module 320 that, when connected with the control module 310, can be used to analyze the location of dirt.

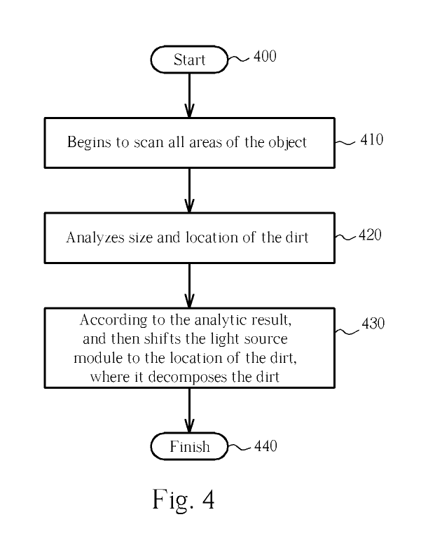

Please refer to FIG. 4. FIG. 4 is a flow chart of removing dirt in the scanner 200.

The steps are as follows:

Step 400: Start; User determines a cleaning order;

Step 410: Scanner 200 starts to scan all areas of the object;

Step 420: Analysis module 320 analyzes size and location of the dirt;

Step 430: According to the analytic result of the analysis module 320, the control module 310 moves the mobile light source module 220 to the location of the dirt and operate the mobile light source module 220 for a time period on the location to decompose the dirt; and

Step 440: Finish.

The surface of the transparent plate 210 probably has some dirt on it. Users can give the scanner 200 a cleaning order (Step 400) via a user interface (not shown). Therefore, the scanner 200 will begin to scan the entire area of the transparent plate 210 after receiving the cleaning order (Step 410) such that a scanning result is generated. Please note, when the scanner 200 is scanning, the transparent plate 210 does not carry any object or document on it in order to prevent from any unexpected scanning errors. Secondly, the analysis module 320 will analyze the size and location of dirt according to the scanning result of the scanner 200 and then sends a control signal to the control module 310 (Step 420).

After the control module 310 receives the control signal from the analysis module 320, the control module 310 moves the mobile light source module 220 to the location of dirt, and remains the mobile light source module 220 for a time period at the location of dirt. Obviously, the photocatalyst reaction is triggered due to the cooperation of the mobile light source module 220 and the catalyst layer (titania layer) such that the dirt on the location is decomposed (Step 430). After the time period, this means the dirt is almost decomposed. The control module 310 will move the mobile light source module 220 back to its original location and finish the cleaning processes.

Please note that the present invention does not limit the above-mentioned time period of the dirt-decomposing operation. In other words, the time period can be determined according to different design requirements.

Moreover, in the above disclosure, the scanner 200 is only utilized as an embodiment, not a limitation of the present invention. In the actual implementation, the above-mentioned dirt-cleaning method and related photocatalyst mechanism can also be used in printers, photostats, multi-function peripheral devices or any other electronic equipments. These changes also obey the spirit of the present invention. That is, the present invention can be utilized in all kinds of electronic office equipment (multi-function peripheral devices etc.) having a scan or print functions, so the present invention can utilize a light source module, transparent plate of the multi-function peripheral devices, and coat surfaces with a catalyst to successfully remove dirt by a photocatalyst reaction.

In contrast to the prior art, the electric device of the present invention can remove dirt by itself. Therefore, when a scanning/printing operation is performed, the scanning/printing quality will not be affected by dirt. Users do not need to additionally purchase cleaning cloths or any other cleaning tools. In other words, the present invention provides not only a low-cost solution, but also a more convenient one.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, which can clean itself, comprising:
a main body;
a mobile light source module disposed within the main body;
a transparent plate disposed on the main body and opposite to the mobile light source module; and
a photocatalyst layer applied on the transparent plate for receiving light illuminated from the mobile light source module so as to trigger a photocatalyst reaction.

2. The electronic device of claim 1, wherein the mobile light source module comprises:
a visible light source for illuminating an object with visible light; and
an ultraviolet light source for illuminating the photocatalyst layer with ultraviolet light to trigger the photocatalyst reaction.

3. The electronic device of claim 1, further comprising:
an analysis module for determining a position for the photocatalyst reaction on the transparent plate so as to produce an output signal; and
a control module coupled with the analysis module, for driving the mobile light source module to the position for the photocatalyst reaction according to the output signal.

4. The electronic device of claim 3, wherein the electronic device is a scanner when the transparent plate does not carry the object, the scanner is capable of scanning the transparent plate to produce a scan result, and the analysis module is used to analyze the scan result so as to determine the position on the transparent plate for the photocatalyst reaction.

5. The electronic device of claim 3, being a multi-function peripheral device with a scan function, and the multi-function peripheral device having a scanner module, wherein the mobile light source module is disposed on the scanner module, and when the transparent plate does not carry the object, the scanner module is capable of scanning the transparent plate to produce a scan outcome, and the analysis module is used to analyze the scan outcome so as to determine the position on the transparent plate for the photocatalyst reaction.

6. The electronic device of claim 1, wherein the electronic device is a scanner.

7. The electronic device of claim 1, wherein the electronic device is a printer.

8. The electronic device of claim 1, wherein the electronic device is a multi-function peripheral device with at least a scan or print function.

9. A method for removing a particular substance on an electronic device that includes a light source module, a transparent plate, and a photocatalyst layer applied on the transparent plate so as to receive light illuminated from the mobile light source module and trigger a photocatalyst reaction, the method comprising:
determining a position on the transparent plate for the photocatalyst reaction to take place; and
driving the mobile light source module to the position.

10. The method of claim 9, wherein the mobile light source module is disposed on a scanner module and the step of determining the position on the transparent plate for the photocatalyst reaction to take placetransparent plate further comprises:
when the transparent plate does not carry an object, the scanner module is capable of scanning the transparent plate so as to produce a scan outcome; and
analyzing the scan outcome so as to determine the position on the transparent plate for the photocatalyst reaction to take place.

11. The method of claim 9, wherein the method is utilized in a scanner.

12. The method of claim 9, wherein the method is utilized in a printer.

13. The method of claim 9, wherein the method is utilized in a multi-function peripheral device with at least a scan or print function.
